(19) United States
(12) Patent Application Publication
(10) Pub. No.: US 2012/0131113 A1
(43) Pub. Date: May 24, 2012

(54) FILE SHARING METHODS

(75) Inventors: Johnny Chen, Santa Ana, CA (US); Gary Kung, Santa Ana, CA (US)

(73) Assignee: I O INTERCONNECT, LTD., Santa Ana, CA (US)

(21) Appl. No.: 13/052,053

(22) Filed: Mar. 19, 2011

Related U.S. Application Data
(60) Provisional application No. 61/416,289, filed on Nov. 22, 2010.

(51) Int. Cl. G06F 15/16

(52) U.S. Cl. 709/206; 709/218

(57) ABSTRACT

A file sharing method for sharing data in a local area network includes obtaining information pertinent to one or more file(s), transmitting the information pertinent to the one or more file(s) in the local area network, selecting one or more of the one or more file(s) based on the information, and transmitting the one or more selected file(s) in the local area network. Data size of the information is smaller than data size of the one or more file(s).

### CROSS REFERENCE TO RELATED APPLICATIONS

This application claims the benefit of U.S. Provisional Application No. 61/416,289, filed on Nov. 22, 2010 and entitled “File sharing system and method”.

### BACKGROUND OF THE INVENTION

1. Field of the Invention

The invention relates to a file sharing system and method, and more particularly to a file sharing system and method with improved security and bandwidth efficiency.

2. Description of the Related Art

Electronic devices, such as personal computers, personal communication devices, personal digital assistants, laptop computers, tablet computers, or others, are commonly used currently, since they provide users with convenient voice and data communication and network access functions.

Conventionally, when using the electronic device to share a file with other user(s) in a local network, the electronic device user has to manually set up some security related fields of the file or folder, such as a user name and password, so as to give the right for other user(s) to access that file. However, once the password is intentionally deciphered by someone not given the right, security of the shared file cannot be protected anymore.

Therefore, a novel file sharing system and method with improved security and further with improved bandwidth efficiency is highly required.

### BRIEF SUMMARY OF THE INVENTION

File sharing methods are provided. An exemplary embodiment of a file sharing method for sharing data in a local area network comprises obtaining information pertinent to one or more file(s), transmitting the information pertinent to the one or more file(s) in the local area network, selecting one or more of the one or more file(s) based on the information, and transmitting the one or more selected file(s) in the local area network. Data size of the information is smaller than data size of the one or more file(s).

An exemplary embodiment of a machine readable storage medium comprising a computer program which, when executed, causes an electronic device to perform: detecting one or more assigned sharing folder(s); obtaining information pertinent to a plurality of files stored in the one or more assigned sharing folder(s), wherein data size of the information is smaller than data size of the files; generating a file sharing message comprising the information pertinent to the files; transmitting the file sharing message in a local area network; receiving one or more data access request message(s) from one or more peer electronic device(s) receiving the file sharing message in the local area network; and in response to the data access request message(s), determining one or more of the files to be shared, and transmitting the one or more determined files to the peer electronic device(s), is provided.

An exemplary embodiment of a machine readable storage medium comprising a computer program which, when executed, causes an electronic device to perform: listening to a file sharing message comprising information pertinent to a plurality of files to be shared in a local area network, wherein data size of the information is smaller than data size of the files; providing an interface to present the information to a user; obtaining information pertinent to one or more of the files selected by the user from the interface; generating a data access request message comprising the information pertinent to the one or more selected file(s); and transmitting the data access request message in the local area network, is provided.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 a flow chart showing a concept of a file sharing method according to an aspect of the invention;

FIG. 2 shows an exemplary file sharing system comprising a plurality of electronic devices with files shared therebetween according to an embodiment of the invention;

FIG. 3 shows a flow chart of a file sharing method, from a provider's perspective, according to an embodiment of the invention;

FIG. 4 shows a message and data flow between a provider and a client according to an embodiment of the invention;

FIG. 5 shows the message flow between a provider and a client according to an embodiment of the invention;

FIG. 6 shows a flow chart of a file sharing method, from a client's perspective, according to an embodiment of the invention; and

FIG. 7 shows an exemplary interface according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

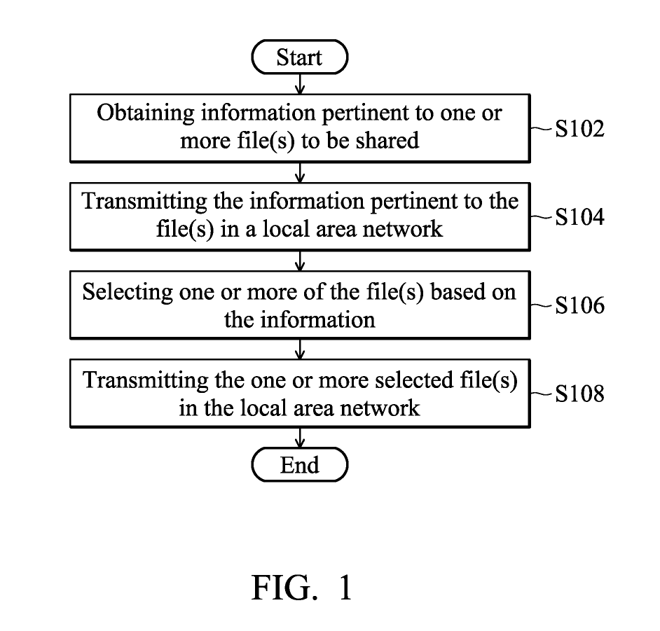

FIG. 1 is a flow chart showing a concept of a file sharing method according to an aspect of the invention. According to the concept of the invention, instead of directly transmitting the data content of one or more file(s) to be shared, information pertinent to the file(s) may be actively transmitted from provider(s) (i.e. file provider) to client(s) (i.e. file subscriber) first in a local area network. As shown in FIG. 1, information pertinent to one or more file(s) to be shared is first obtained by the provider(s) (Step S102). According to an embodiment of the invention, the information pertinent to the one or more file(s) comprises directories, folders and/or file names of the one or more file(s). Next, the obtained information is transmitted by the provider(s) in a local area network (Step S104). Next, any client in the local area network receiving the information may select one or more of the file(s) based on the received information (Step S106). Finally, the selected file(s) may be transmitted by the provider(s) in the local area network. Because data size of the information pertinent to the file(s) is much smaller than data size of the content of the file(s), the transmission bandwidth is greatly saved in the beginning of a file sharing procedure. In addition, by managing the transmission of the selected file(s) requested by different clients in the local area network (which will be discussed in more detailed in the following paragraphs), the transmission bandwidth can also be greatly saved when sharing the selected file(s).

According to the embodiments of the invention, a file-sharing application program may be utilized to facilitate the above-mentioned file sharing procedure. By executing the file-sharing application program, it is easy for a user to share the files by just moving the files to be shared in assigned sharing folders, without manually setting up any security related fields for each file or folder as required in conventional design. In addition, only the devices having the file-sharing application program installed therein may be aware of the shared folders, so as to protect the security and integrity of the shared files.

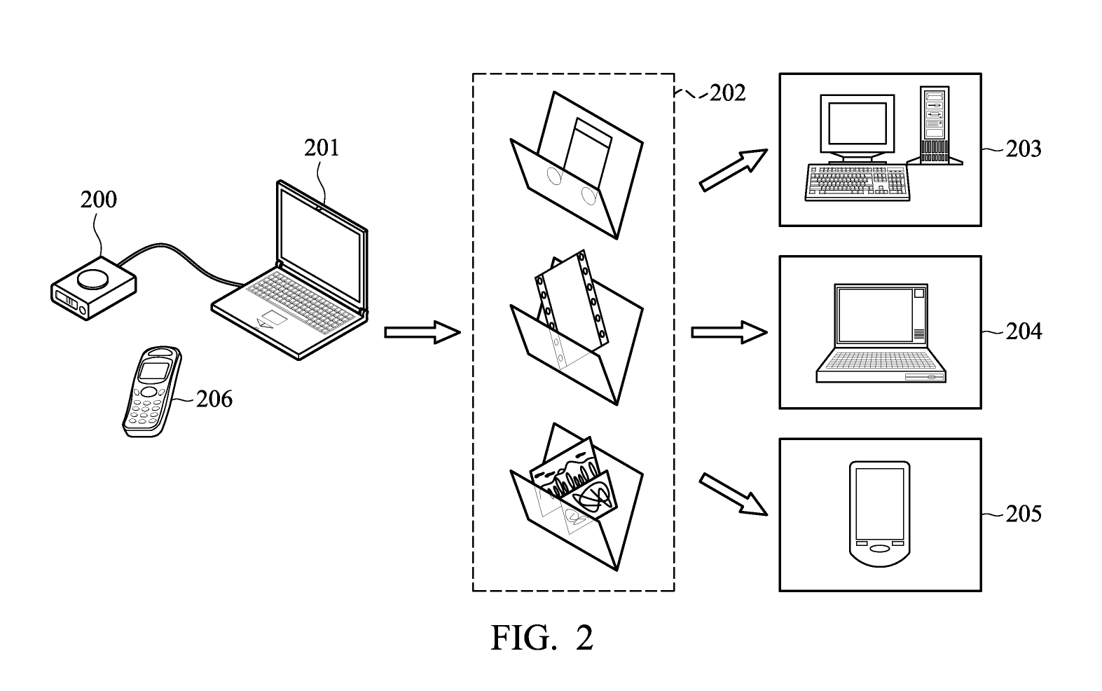

FIG. 2 shows an exemplary file sharing system comprising a plurality of electronic devices with files shared therebetween according to an embodiment of the invention. According to an embodiment of the invention, any peer electronic devices, such as but not limited to the personal computer, notebook and mobile phone as shown in FIG. 2, having the above-mentioned file-sharing application program installed therein may join the file sharing system, and act as either a provider or a client. For example, the electronic device 201 having a storage device 200 coupled thereto and the electronic device 206 may act as the providers sharing files to other peers in the file sharing system. The other peer electronic devices 203, 204 and/or 205 may act as the clients in the file sharing system.

A plurality of assigned sharing folders with files, such as but not limited to music, pictures, movies, or others, to be shared may be stored in the storage device 200, the electronic device 201, or the electronic device 206. According to the embodiments of the invention, the file-sharing application program may be installed in either the storage device side or the electronic device side. For example, when the file-sharing application program is installed in the storage device 200, as the storage device 200 is connected to the electronic device 201, the file-sharing application program may be automatically started, and executed by a processing unit of the electronic device 201. When the file-sharing application program is installed in the electronic device side, the file-sharing application program may be directly executed by the processing unit of the electronic devices 201 and 206, and detect that whether there is any assigned sharing folder created in the storage device 200 or the electronic devices 201 and 206. If there is no assigned sharing folder created, the sharing folders for containing the files that a user would like to share with other peers may be also created by the electronic devices 201 and 206. Note that according to yet other embodiments of the invention, the file-sharing application program may also be installed in the storage device side, and automatically started and executed by a processing unit of the storage device 200, and the invention should not be limited thereto.

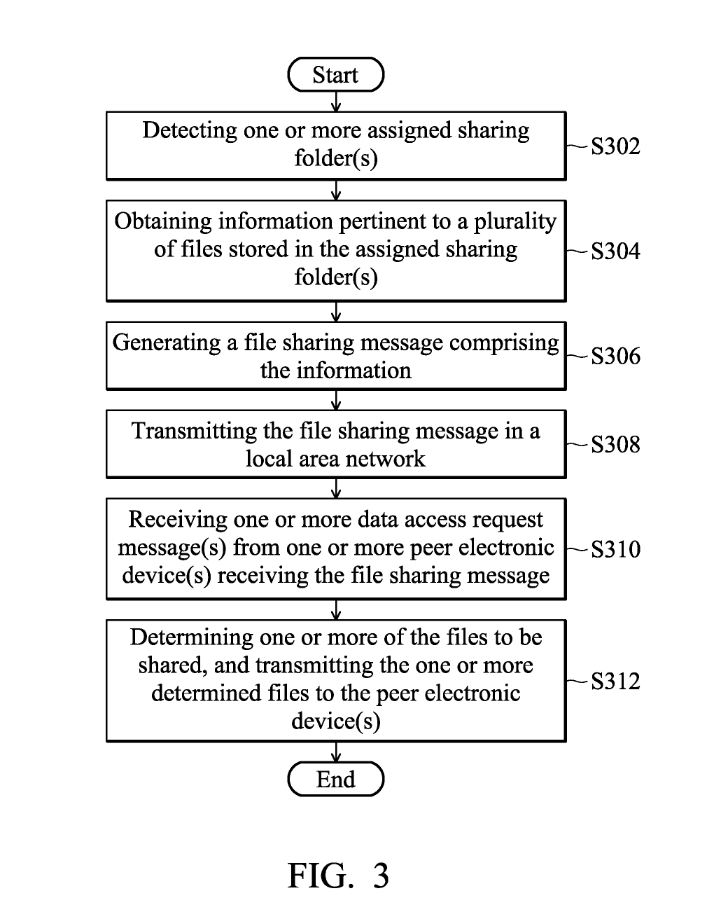

FIG. 3 shows a flow chart of a file sharing method, from a provider's perspective, according to an embodiment of the invention. As a provider in the file sharing system, according to an embodiment of the invention, the file-sharing application program, when executed, may cause an electronic device (the provider) to perform detecting of one or more assigned sharing folder(s) (Step S302) and obtaining information pertinent to a plurality of files stored in the assigned sharing folder(s) (Step S304). As previously described, data size of the information is smaller than data size of the content of the files. After obtaining the information, the file-sharing application program, when executed, may further cause the electronic device (the provider) to perform generating of a file sharing message comprising the information pertinent to the files (Step S306), and transmitting the file sharing message in a local area network (Step S308). After transmitting the file sharing message, the file-sharing application program, when executed, may further cause the electronic device (the provider) to perform receiving of one or more data access request message(s) from one or more peer electronic device(s) receiving the file sharing message in the local area network (Step S310), and finally, in response to the data access request message(s), determining of one or more of the files to be shared, and transmitting of the one or more determined files to peer electronic device(s) (Step S312).

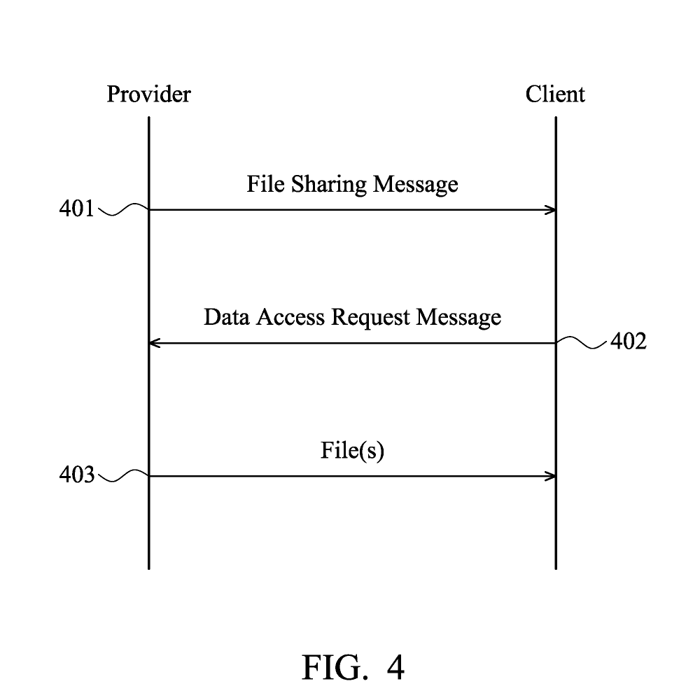

FIG. 4 shows a message and data flow between a provider and a client according to an embodiment of the invention. As shown in FIG. 4, the provider may transmit a file sharing message 401 comprising the information pertinent to the files stored in the assigned sharing folders to a predetermined network address in the local area network, receive one or more data access request message(s) 402 from one or more peer electronic device(s) receiving the file sharing message in the local area network, and transmit one or more files 403 selected by the peer electronic device(s).

According to an embodiment of the invention, the file-sharing application program, when executed, may cause the electronic device (the provider) to transmit the file sharing message 401 by broadcasting (i.e. one to all) the information in the local area network, so that all the clients having the file-sharing application program installed therein may receive the information. According to another embodiment of the invention, the file-sharing application program, when executed, may also cause the electronic device (the provider) to transmit the file sharing message 401 by multicasting (i.e. one to many) the information to a group of clients having the file-sharing application program installed therein, so that the clients joining in the group may receive the information. According to yet another embodiment of the invention, the file-sharing application program, when executed, may also cause the electronic device (the provider) to transmit the file sharing message 401 by unicasting (i.e. one to one) the information directly to a specific client having the file-sharing application program installed therein. In the following paragraphs, the detailed embodiments for broadcasting, multicasting, or unicasting the file sharing message 401 are introduced.

For the broadcasting case, according to an embodiment of the invention, the provider may transmit the file sharing message 401 to a predetermined broadcast address, such as 255.255.255.255. The clients in the same local area network and having the file-sharing application program installed therein may listen to the broadcast address and receive the file sharing message 401. The clients may further obtain the IP address of the provider from the file sharing message 401. Thereafter, the clients may establish a peer to peer connection, or a peer to peer group connection with the provider, and begin to access the files stored in the assigned sharing folders.

For the multicasting case, according to an embodiment of the invention, the provider may transmit the file sharing message 401 to one or more predetermined multicast addresses. For a predetermined multicast address, there may be a group corresponding thereto. Any devices located within the internet or the local area network and joined within a group may receive the message transmitted to the corresponding multicast address. The clients may further obtain the IP address of the provider from the received file sharing message 401. Thereafter, the clients may establish a peer to peer connection, or a peer to peer group connection with the provider, and begin to access the files stored in the assigned sharing folders. The information pertinent to the corresponding groups of predetermined multicast addresses may be transmitted to the clients in many ways.

For example, in one embodiment, the provider may first obtain the information pertinent to one or more multicast group(s) corresponding to predetermined multicast addresses, and broadcast a group information message 501 comprising the information pertinent to one or more multicast group(s) in the local area network before multicasting the file sharing message 401.

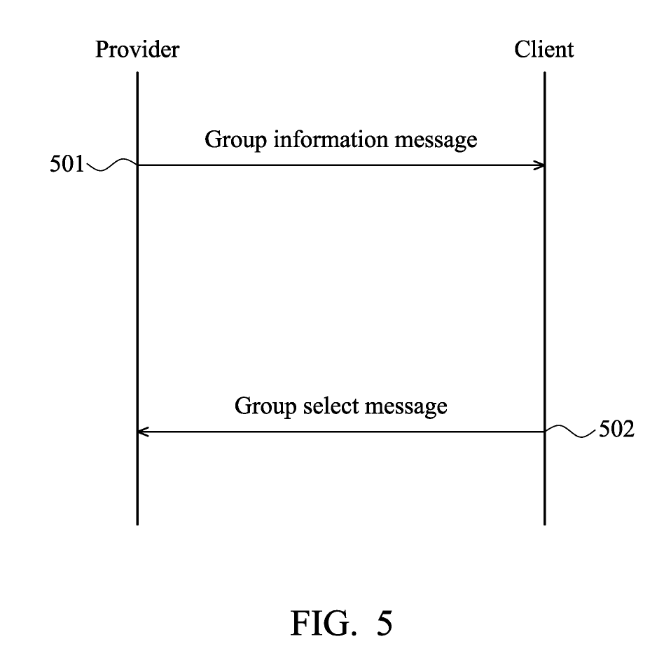

FIG. 5 shows the message low between a provider and a client according to an embodiment of the invention. The file-sharing application program, when executed, may cause the electronic device (the provider) to perform obtaining of information pertinent to one or more multicast group(s), generating a group information message 501 comprising the information pertinent to the one or more multicast group(s), and broadcasting the group information message 501 in the local area network. In response to the group information message 501, the file-sharing application software may further facilitate the client to choose and join in with one group, so that the client could receive the messages transmitted to the corresponding multicast address. For example, the file-sharing application software, when executed, may cause the electronic device (the client) to perform listening to the group information message, presenting of the information pertinent to the one or more multicast group(s) to the user through an user interface, and obtaining of information pertinent to one multicast group selected by the user from the user interface. The file-sharing application software, when executed, may further cause the electronic device (the client) to transmit a group select message 502 comprising the information pertinent to the selected multicast group to the provider. In response to the group select message 502, the file-sharing application program, when executed, may cause the electronic device (the provider) to join the client in the selected multicast group and transmit the file sharing message 401 to the multicast address corresponding to the selected multicast group.

For another example, in another embodiment, the multicast addresses and the corresponding groups may be predefined and hard coded in the file-sharing application program. In this manner, the file-sharing application program may facilitate the client to directly choose and join in with one group (that is, there is no need to listen to the broadcasted group information) so that the client may receive the file sharing message 401 transmitted to the corresponding multicast address.

For the unicasting case, according to an embodiment of the invention, the file-sharing application program, when executed, may cause the electronic device (the provider) to directly unicast the file sharing message 401 to a specific client (for example, to an IP address of the client) having the file-sharing application program installed therein. Upon receiving the file sharing message 401, the client may further obtain the IP address of the provider from the received file sharing message 401. Thereafter, the client having the file-sharing application program installed therein may establish a peer to peer connection, or a peer to peer group connection with the provider, and begin to access the files stored in the assigned folders.

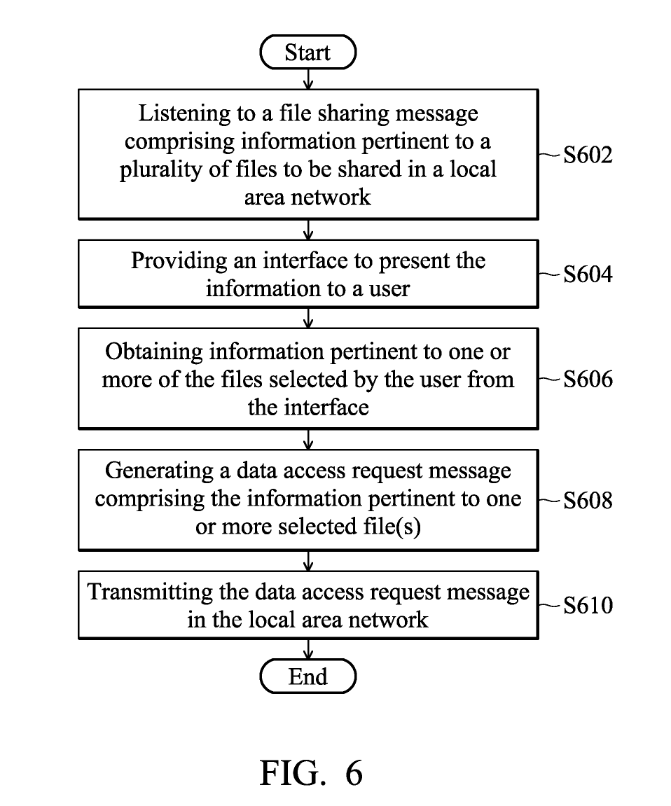

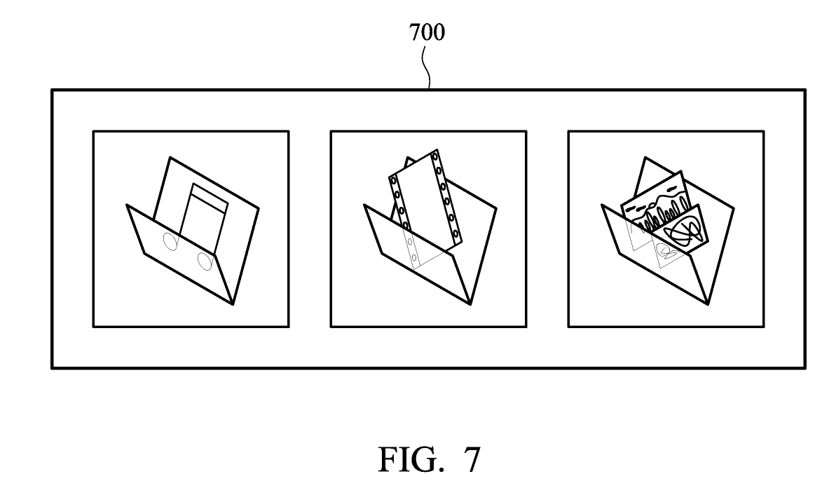

Upon receiving the file sharing message 401 carrying information pertinent to the directory of the assigned sharing folders and/or filenames of the files stored in the assigned sharing folders, the file-sharing application program, when executed, may also cause the electronic device (the client) to establish a peer to peer connection, or a peer to peer group connection with the provider, and begin to access the files stored in the assigned sharing folders. FIG. 6 shows a flow chart of a file sharing method, from a client's perspective, according to an embodiment of the invention. As a client in the file sharing system, according to an embodiment of the invention, the file-sharing application program, when executed, may cause an electronic device (the client) to perform listening to a file sharing message comprising information pertinent to a plurality of files to be shared in a local area network (Step S602), and providing of an interface to present the information to a user (Step S604). FIG. 7 shows an exemplary interface according to an embodiment of the invention. The interface 700 may be a user interface (UI) displayed on the screen of the electronic device. The information 202 transmitted by the provider as shown in FIG. 2 may be presented on the interface 700 as some kind of picture or drawings, such as folders shown in FIG. 7. The user may further see the file names of the files to be shared after double clicking a folder, just like the normal operation. Note that FIG. 7 only shows one example of the interface, and the invention should not be limited thereto.

After presenting the information to the user, the file-sharing application program, when executed, may cause an electronic device (the client) to perform obtaining of information pertinent to one or more of the files selected by the user from the interface (Step S606), generating of a data access request message comprising the information pertinent to one or more selected file(s) (Step S608) and transmitting of the data access request message in the local area network (Step S610).

Referring back to FIG. 4, according to the embodiments of the invention, the file-sharing application program may facilitate the client to transmit the data access request message 402 to one or more provider(s) by broadcasting (i.e. one to all), multicasting (i.e. one to many) or unicasting (i.e. one to one) and the invention should not be limited thereto. Note that in some embodiments of the invention, there may be more than one provider existing within the file sharing system. The file-sharing application program may facilitate the client to determine the access of files from one provider, or from multiple providers having the same files, and the invention is not limited to either cases. When the client determines to access files from multiple providers having the same files, the data access request message 402 may be transmitted to the providers by broadcasting, multicasting or unicasting The concepts of broadcasting/multicasting/unicasting the data access request message 402 are similar to those of the file sharing message 401 as introduced above, and are omitted here for brevity.

In addition, according to some embodiments of the invention, the provider may also receive the data access request message 402 from different clients, and the file-sharing application program may facilitate the provider to determine whether to transmit the selected file(s) by directly unicasting the selected file(s), or by multicasting the selected file(s) to multiple clients when they have selected the same file(s). For example, the provider may receive a first data access request message comprising information pertinent to one or more file(s) selected by a first client and a second data access request message comprising information pertinent to one or more file(s) selected by a second client. The provider may further determine whether the file(s) selected by the second client is/are the same as the file(s) selected by the first client. When there is any file selected by the second client which is the same as the file selected by the first client, the provider may determine a multicast group for transmitting the file, inform the first and second clients of the multicast address corresponding to a multicast group for receiving the file, and transmit the file to the multicast address. The concepts of multicasting/unicasting the content of the selected file(s) 403 are similar to those of the file sharing message 401 as introduced above, and are omitted here for brevity.

According to the embodiments of the invention, by managing the transmission of the selected file(s) requested by different clients in the local area network, for example, establishing a peer to peer group connection between the provider(s) and the client(s) as previously described, the content of the selected file(s) may be multicast to different clients, instead of individually being unicast to different clients, and the transmission bandwidth can be greatly saved.

According to an embodiment of the invention, the file sharing method as described above, or certain aspects or portions thereof, may take the form of a program code (i.e., executable instructions), such as the above-mentioned file-sharing application program, embodied in tangible media, such as floppy diskettes, CD-ROMS, hard drives, or any other machine-readable storage medium, wherein, when the program code is loaded into and executed by a machine or an electronic device, such as a computer, a cell phone, or other, and the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, a cell phone, or other, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A file sharing method for sharing data in a local area network, comprising:
obtaining information pertinent to one or more file(s), wherein data size of the information is smaller than data size of the one or more file(s);
transmitting the information pertinent to the one or more file(s) in the local area network;
selecting one or more of the one or more file(s) based on the information; and
transmitting the one or more selected file(s) in the local area network.

2. The file sharing method as claimed in claim 1, wherein the information pertinent to the one or more file(s) comprises directories, folders and/or file names of the one or more file(s).

3. The file sharing method as claimed in claim 1, wherein the information pertinent to the one or more file(s) is broadcasted in the local area network.

4. The file sharing method as claimed in claim 1, wherein the information pertinent to the one or more file(s) is multicast in the local area network.

5. The file sharing method as claimed in claim 1, wherein the information pertinent to the one or more file(s) is unicast in the local area network.

6. The file sharing method as claimed in claim 1, wherein the one or more selected file(s) is/are transmitted by multicasting in the local area network.

7. The file sharing method as claimed in claim 1, wherein the one or more selected file(s) is/are transmitted by unicasting in the local area network.

8. A machine readable storage medium comprising a computer program which, when executed, causes an electronic device to perform:
detecting one or more assigned sharing folder(s);
obtaining information pertinent to a plurality of files stored in the one or more assigned sharing folder(s), wherein data size of the information is smaller than data size of the files;
generating a file sharing message comprising the information pertinent to the files;
transmitting the file sharing message in a local area network;
receiving one or more data access request message(s) from one or more peer electronic device(s) receiving the file sharing message in the local area network; and
in response to the data access request message(s), determining one or more of the files to be shared, and transmitting the one or more determined files to the peer electronic device(s).

9. The machine readable storage medium as claimed in claim 8, wherein the computer program is automatically executed when the machine readable storage medium is coupled to the electronic device.

10. The machine readable storage medium as claimed in claim 8, wherein the information pertinent to the files comprises file names of the files, and/or directories of the assigned sharing folder(s).

11. The machine readable storage medium as claimed in claim 8, wherein the file sharing message is broadcasted in the local area network.

12. The machine readable storage medium as claimed in claim 8, wherein the file sharing message is multicast in the local area network.

13. The machine readable storage medium as claimed in claim 12, wherein the computer program, when executed, further causes the electronic device to perform:
obtaining information pertinent to one or more multicast group(s);
generating a group information message comprising the information pertinent to the one or more multicast group(s); and
broadcasting the group information message in the local area network before multicasting the file sharing message.

14. The machine readable storage medium as claimed in claim 13, wherein the computer program, when executed, further causes the electronic device to perform:
receiving a group select message indicating one of the multicast group(s) selected by the peer electronic device(s); and
in response to the group select message, joining the peer electronic device(s) in the selected multicast group and transmitting the file sharing message to a multicast address corresponding to the selected multicast group.

15. A machine readable storage medium comprising a computer program which, when executed, causes an electronic device to perform:
listening to a file sharing message comprising information pertinent to a plurality of files to be shared in a local area network, wherein data size of the information is smaller than data size of the files;
providing an interface to present the information to a user;
obtaining information pertinent to one or more of the files selected by the user from the interface;
generating a data access request message comprising the information pertinent to the one or more selected file(s); and
transmitting the data access request message in the local area network.

16. The machine readable storage medium as claimed in claim 15, wherein the information pertinent to the files comprises directories, folders and/or file names of the files.

17. The machine readable storage medium as claimed in claim 15, wherein the data access request message is broadcasted to one or more peer electronic device(s) transmitting the file sharing message in the local area network.

18. The machine readable storage medium as claimed in claim 15, wherein the data access request message is multicast to one or more peer electronic device(s) transmitting the file sharing message in the local area network.

19. The machine readable storage medium as claimed in claim 15, wherein the data access request is unicast to a peer electronic device transmitting the file sharing message in the local area network.

20. The machine readable storage medium as claimed in claim 15, wherein the computer program, when executed, further causes the electronic device to perform:
receiving the one or more selected file(s) from one or more peer electronic device(s) receiving the data access request message.

21. The machine readable storage medium as claimed in claim 15, wherein the computer program, when executed, further causes the electronic device to perform:
listening to a group information message comprising information pertinent to one or more multicast group(s);
presenting the information pertinent to the one or more multicast group(s) to the user through the interface; and
obtaining information pertinent to one multicast group selected by the user from the interface.

22. The machine readable storage medium as claimed in claim 21, wherein the computer program, when executed, further causes the electronic device to perform:
generating and transmitting of a group select message comprising the information pertinent to the selected multicast group; and
listening to the file sharing message at a multicast address corresponding to the selected multicast group.
